(19) United States
(12) Patent Application Publication
(10) Pub. No.: US 2024/0082974 A1
(43) Pub. Date: Mar. 14, 2024

(54) Protective Cover For Covering Movable Machine Parts

(71) Applicant: ARNO ARNOLD GMBH, Obertshausen (DE)

(72) Inventors: Benedikt Himbert, Obertshausen (DE); Isabelle Himbert, Obertshausen (DE)

(21) Appl. No.: 18/243,434

(22) Filed: Sep. 7, 2023

(30) Foreign Application Priority Data
Sep. 9, 2022 (DE) 10 2022 122 950.5

(51) Int. Cl. B23Q 11/08

(52) U.S. Cl. CPC B23Q 11/0816

(57) ABSTRACT

A protective cover having at least one supporting profile and having at least one length-adjustable protective cover element, the supporting profile having a first connecting means for detachably connecting the protective cover element, and the protective cover being movable in a direction of movement within a predetermined range of movement, which is defined between a first position of the protective cover and a second position of the protective cover, the supporting profile being rotatably mounted around an axis in such a manner that the height of the cross section of the supporting profile is disposed essentially perpendicular to the direction of movement in the first position and parallel to the direction of movement in the second position.

### CROSS-REFERENCE TO RELATED APPLICATIONS

This application claims priority to German Patent Application No. DE 10 2022 122 950.5 filed Sep. 9, 2022. The contents of this application are hereby incorporated by reference as if set forth in its entirety herein.

The disclosure relates to a protective cover for covering movable machine parts according to the preamble of claim 1 and to a machine comprising the protective cover according to claim 16.

Protective covers are known from the state of the art and serve in particular, but by no means exclusively, for covering movable machine parts or the like. Typically, protective covers known from the state of the art have length-adjustable protective cover elements by means of which the machine parts are not only protected both in the retracted and in the extended state against external influences, such as chips, dust particles or other pollution, but can also be sealed against the environment. Since the protective cover elements are length-adjustable, the total length of the protective cover itself is also length-adjustable. Length-adjustable protective covers of this kind are connected to a frame element and/or a support frame which serve(s) to stabilize said protective covers, in particular to support said protective covers. DE 10 2006 033 607 B4 and DE 20 2012 008 987 Ul are to be noted as examples.

However, the protective covers known from the state of the art have proven to be disadvantageous in the sense that the used support frames and/or frame elements do not have the required preload force and/or support in order to displace the protective cover in a smooth and resistance-free manner, since they are shiftably mounted on a guide in a manner susceptible to faults and they often sag and thus do not provide the movable machine parts with any seal against the environment. This is in particular the case with very large, heavy protective covers, such as those typically used as roof covers. Another disadvantage is that the protective covers can only be displaced using great force.

Hence, there is great demand for a protective cover which can be displaced in a simple, reliable, long-term, smooth and resistance-free manner. Furthermore, the protective cover should ensure the required preload force and/or support in a simple and reliable manner and ensure that the movable machine parts are sealed against the environment as required. Another focus is on the cost-effective manufacturability, the durability of the protective cover and the individual adaptability of the protective cover to the area of the machine to be protected. Furthermore, the protective cover should preferably be designed so as to be compact and require little installation space. Hence, the object of the disclosure is to provide a protective cover in order to overcome the difficulties mentioned above and especially to guarantee that the protective cover can be displaced reliably using as little installation space as possible.

This object is attained in a surprisingly simple but effective manner by a protective cover according to the teachings of the independent main claim 1 and a machine comprising the protective cover according to the teachings of the independent main claim 16.

The disclosure proposes a protective cover having at least one supporting profile and having at least one length-adjustable protective cover element, the supporting profile having a first connecting means for detachably connecting the protective cover element and the protective cover being movable in a direction of movement within a predetermined range of movement, which is defined between a first position of the protective cover and a second position of the protective cover. The protective cover is characterized in that the supporting profile is rotatably mounted around an axis, in such a manner that the height of the cross section of the supporting profile is disposed essentially perpendicular to the direction of movement in the first position of the protective cover and that the height of the cross section of the supporting profile is disposed parallel to the direction of movement in the second position of the protective cover.

The protective cover according to the disclosure is based on the idea that the supporting profile, which forms a unit with the length-adjustable protective cover element, significantly contributes to the dimensions of the protective cover when it is extended. This is made possible by the fact that, on the one hand, the supporting profile is rotatably mounted around the axis that can be moved in the direction of movement predetermined by the range of movement, such that the height of the cross section of the supporting profile is disposed essentially perpendicular to the direction of movement in the first position of the protective cover and that the height of the cross section of the supporting profile is disposed parallel to the direction of movement in the second position of the protective cover. This is also made possible by the protective cover element which is detachably connected to the supporting profile. Furthermore, the axis ensures that the introduced energy, the force and/or the momentum can be converted into a defined movement in the predetermined range of movement and thus preferably in two directions of movement, i.e. back and forth. In this manner, it is possible to ensure that the protective cover can be displaced smoothly, reliably and without resistance while allowing for maximum extension and maximum access.

The term “protective cover” refers in particular, but by no means exclusively, to a cover of movable machine parts, such as machine tools or the like. In connection with the disclosure, the term thus refers to the entire protective cover, a part thereof and/or at least one element thereof. The protective cover according to the disclosure comprises at least one supporting profile and at least one length-adjustable protective cover element. The protective cover, in particular the supporting profile and the protective cover element, is/are movable, in particular guided so as to be movable, within a predetermined range of movement. The term “predetermined range of movement” refers to the direction of extension of the protective cover, i.e. the direction of movement in which the protective cover can be displaced back and forth any number of times and thus be moved. The predetermined range of movement is defined between a first position of the protective cover and a second position of the protective cover. Preferably, it is conceivable that the first position of the protective cover defines the minimum extension width of the protective cover, so that the access area into the machinery to be protected is open. Furthermore, it is conceivable that the second position of the protective cover is defined by the maximum extension width of the protective cover, so that the machine to be protected cannot be accessed. Preferably, the protective cover is movable within the predetermined range of movement and thus in at least one, preferably two, direction(s) of movement, i.e. back and forth. A person skilled in the art knows corresponding possibilities for the defined movement and/or guidance of components.

The term “supporting profile” comprises at least one profile serving to support the protective cover element detachably connected to the supporting profile, the profile being movable, i.e., capable of being displaced or shifted, between the first position and the second position in the predetermined range of movement of the protective cover, i.e., in at least one, preferably two direction(s) of movement. In the context of the disclosure, it is intended that the supporting profile is distributed over the entire length of the protective cover at equal intervals. The protective cover comprises at least one, preferably at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, identically or differently designed supporting profile(s).

According to the disclosure, the supporting profile is rotatably mounted around an axis, which is movable, preferably smoothly movable, in the at least one, preferably two, direction(s) of movement which is/are predetermined by the range of movement, in such a manner that the height of the cross section of the supporting profile is disposed essentially perpendicular to the direction of movement in the first position and the height of the cross section of the supporting profile is disposed parallel, preferably essentially parallel, to the direction of movement in the second position of the protective cover. Within the scope of the disclosure, the design of the axis is not of significance as long as the movement capacity of the supporting profile described above can be realized. Axes of this kind known to the person skilled in the art include, but are not limited to, a rod, a band, a rope, a flat bar or the like.

Within the scope of the disclosure, it has been discovered that it is essential that the supporting profile has a first connecting means by means of which the length-adjustable protective cover element can be detachably connected, in particular directly or indirectly connected. Suitable first connecting means for realizing a direct or indirect connection are known to a person skilled in the art. A direct and detachable connection can be realized by establishing a connection simply through a direct contact of the first connecting means with the protective cover element, for example by pushing them together, and the connection can be detached by pushing them apart. An indirect and detachable connection can be realized by means of a suitable connecting element, for example. Furthermore, it has been discovered that it is essential that the supporting profile and the protective cover element form a unit, the supporting profile significantly contributing to the dimensions of the protective cover when the same is extended because it is rotatably mounted. It is conceivable that the protective cover also contributes to the extension dimensions of the protective cover by, for example, stretching, rotating and/or elongating said protective cover, largely depending on the material used, which is known to a person skilled in the art. This means that both the supporting profile and the protective cover element protect the movable machine parts against external influences and also seal them against the environment both in the retracted and in the extended state, i.e., in the first position of the protective cover and in the second position of the protective cover.

The term “protective cover element” relates to at least one length-adjustable element which is movable in one, preferably in two, direction(s) of movement predetermined by the range of movement and which protects the movable machine parts against external influences and also seals them against the environment both in the retracted and in the extended state, i.e., in the first position of the protective cover and in the second position of the protective cover. According to the disclosure, at least one, preferably at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, identically or differently designed protective cover element(s) is/are conceivable.

The term “seal” describes a degree of impermeability of the movable machine parts against the environment, i.e., against an external influence, i.e., a substance, a fluid and/or a composite thereof. The term “external influence” relates to, for example, but not exclusively, all influences, which damage the movable machine parts, the machine and/or the environment. Possible are, for example, fluids, such as moisture and/or gases, operating supplies, such as oil and/or lubricants, chips, dust particles and/or other pollution.

A person skilled in the art understands that the term “impermeability” is a relative term and that there is no absolute impermeability of the movable machine parts against the environment. In connection with the disclosure, “seal” or “impermeability” is to be understood to always refer to previously established required and/or predetermined conditions, so that the movable machine part is reliably protected against external influences. It is understood that because of the movement of the machine parts, external influences can temporarily pass through toward the machine or away from the machine. The possibility of external influences temporarily passing through is of minor importance.

For a person skilled in the art in the relevant technical field, it is obvious that the protective cover according to the disclosure is not intended to be absolutely impermeable. Instead, external influences are preferably prevented from passing through to the greatest possible extent in order to prevent damages to the machine and/or a contamination of the environment. More preferably, external influences are entirely prevented from passing through in one of the directions mentioned above, so that an absolute impermeability can be achieved at least in sections or momentarily. The impermeability can also be adjusted by the constructional design of the protective over and/or the machine parts. This, however, is associated with increased costs. In connection with the present disclosure, the level of sealing is at least 90%, 91%, 92%, 93%, 94%, 95%, 96%, 97%, 98%, 99%, 99.5%, 99.6%, 99.7%, 99.8%, 99.9% or more.

In connection with the disclosure, it should be considered that achieving and/or maintaining the required preload force and/or support and the level of sealing of the machine parts against the environment depend significantly on the material used, the site of use, the conditions of use and/or the purpose of the protective cover. The person skilled in the art is aware of this.

The term “movable machine part” is known to a person skilled in the art and relates to the moving/movable part of a machine, in particular a machine tool, to be protected from external influences. The type, size, dimensions and/or design of the machine is/are of minor importance.

By means of the protective cover according to the disclosure, it is thus possible to ensure that the protective cover can be displaced in a consistent, resistance-free, reliable manner and unsusceptible to faults using protective cover elements which are evenly arranged over the length of the protective cover and it is thus possible to reliably seal the movable machine parts against external influences and against influences from the respective environment, depending on the operating conditions. Simultaneously, it is achieved that the work area to be covered by the protective cover is as large as possible because of the compact design of the protective cover. Additionally, it is possible to economize on considerable production and material expenses, in particular because of the design, which is simple, compact and reduced in component diversity. Furthermore, the protective cover according to the disclosure only requires little installation space, so that it is also suitable for covering movable machine parts where the available space for a protective cover is severely limited or difficult to access. Simultaneously, the weight of the protective cover according to the disclosure is very low, so that it is suitable for all conceivable usages.

Advantageous embodiments of the disclosure, which can be realized individually or in combination, are described in the dependent claims. In one embodiment, it is conceivable that the supporting profile has an elongated and/or high cross section which has an ideal stiffness. In the present disclosure, it has been discovered that an elongated and/or high cross section contributes to a low degree of sagging and thus to maintaining the impermeability and the required preload force and/or support of the protective cover. This is achieved by the specific configuration of the supporting profile having an elongated cross section, as the narrow side of the supporting profile carries the weight, i.e., the weight of the supporting profile and the protective cover element, in the second position, and as the axis absorbs the bending moment. In connection with the disclosure, it has been discovered that the elongated and/or high cross section of the supporting profile does not increase the installation height and/or the structural height of the protective cover because said supporting profile is rotatably mounted. According to the disclosure, it is thus possible to use the elongated and/or high cross section of the supporting profile, in particular because of its implementation in the cross section of the protective cover, as extension dimensions of the protective cover. Preferably, the height of the elongated and/or high profile cross section of the supporting profile corresponds to the installation height of the entire protective cover so that the installation space required for the protective cover can be as compact as possible while ideally utilizing the extension proportions of the supporting profile and the protective cover elements.

Furthermore, it is conceivable that the supporting profile is rotatably mounted at an angle α, which is formed between a pivot plane of the supporting profile and the direction of movement, the angle α being 80° to 100° in the first position and/or 0° to 79° in the second position. The term “pivot plane” relates to an imaginary center plane of the supporting profile relating to the rotation axis. According to the disclosure, the supporting profile pivots around the axis which is in the plane of the direction of movement. Preferably, the pivot plane is formed between the axis and a point of the supporting profile opposite the axis, even more preferably between the axis and the first connecting means. It is obvious for a person skilled in the art that, depending on the outer design of the supporting profile, the center plane can also be disposed at an offset to the center of said supporting profile. It is only important that the center plane is located within the maximum outer dimension of the supporting profile. Preferably, the angle α in the first position amounts to at least 80°, 81°, 82°, 83°, 84°, 85°, 86°, 87°, 88°, 89°, 90°, 91°, 92°, 93°, 94°, 95°, 96°, 97°, 98°, 99°, or 100°. More preferably, the angle α in the first position amounts to no more than 100°, 99°, 98°, 97°, 96°, 95°, 94°, 93°, 92°, 91°, 90°, 89°, 88°, 87°, 86°, 85°, 84°, 83°, 820, 81° or 80°. Preferably, the angle α in the second position amounts to at least 0°, 1°, 2°, 3°, 4°, 5°, 6°, 7°, 8°, 9°, 100, 11° 12°, 13°, 14°, 15°, 16°, 17°, 18°, 19°, 20°, 21°, 22°, 23°, 24°, 25°, 26° 27°, 28°, 29°, 30°, 31°, 32°, 33°, 34°, 35°, 36°, 37°, 38°, 39°, 40°, 41° 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 770, 78° or 79°. More preferably, the angle α in the second position amounts to no more than 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2° or 1°. A person skilled in the art understands that in the first position and/or second position, the angle α depends on the specific configuration and on the stiffness of the materials used, i.e., the material of the supporting profile and the material of the protective cover element.

The term “essentially” means that only a slight, in particular insignificant, change in and/or deviation from the conditions occur. Preferably, this change and/or deviation is uniform. In the present disclosure, the term “essentially perpendicular to the direction of movement” means that the height of the cross section of the supporting profile can be disposed between 80° and 100° relative to the direction of movement. Furthermore, the term “parallel” means that the height of the cross section of the supporting profile can be disposed between 0° and 79° relative to the direction of movement, whereas the term “essentially parallel to the direction of movement” means that the height of the cross section of the supporting profile can be disposed between 0° and 50° relative to the direction of movement.

Furthermore, it is conceivable that the protective cover element is rotatably mounted, the protective cover element being rotatably mounted at an angle β, which is formed between the pivot plane of the supporting profile and the center plane of the protective cover element, the angle β being 0° to 180°. As has been described elsewhere in this application, it is obvious to a person skilled in the art that, depending on the outer design of the protective cover element, the center plane can also be disposed at an offset to the center of said protective cover element. It is only important that the center plane is located within the maximum outer dimension of the protective cover element. Preferably, the angle β amounts to at least 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31° 32°, 33°, 34°, 35°, 36°, 37°, 38°, 39°, 40°, 41°, 42°, 43°, 44°, 45°, 46° 47°, 48°, 49°, 50°, 51°, 52°, 53°, 54°, 55°, 56°, 57°, 58°, 59°, 60°, 61° 62°, 63°, 64°, 65°, 66°, 67°, 68°, 69°, 70°, 71°, 72°, 73°, 74°, 75°, 76° 77°, 78°, 79°, 80°, 81°, 82°, 83°, 84°, 85°, 86°, 87°, 88°, 89°, 90°, 91°, 92°, 93°, 94°, 95°, 96°, 97° 98°, 99°, 100°, 101°, 102°, 103°, 104°, 105°, 106° 107°, 108°, 109°, 110°, 111°, 112°, 113°, 114°, 115°, 116°, 117°, 118° 119°, 120°, 121°, 122°, 123°, 124°, 125°, 126°, 127°, 128°, 129°, 130° 131°, 132°, 133°, 134°, 135°, 136°, 137°, 138°, 139°, 140°, 141°, 142° 143°, 144°, 145°, 146°, 147°, 148°, 149°, 150°, 151°, 152°, 153°, 154° 155°, 156°, 157°, 158°, 159°, 160°, 161°, 162°, 163°, 164°, 165°, 166°, 167°, 168°, 169°, 170°, 171°, 172°, 173°, 174°, 175°, 176°, 177°, 178°, 179° or 180°. More preferably, the angle β amounts to no more than 180°, 179°, 178°, 177°, 176°, 175°, 174°, 173°, 172°, 171°, 170°, 169°, 168°, 167°, 166°, 165°, 164°, 163°, 162°, 161°, 160°, 159°, 158°, 157°, 156°, 155°, 154°, 153°, 152°, 151°, 150°, 149°, 148°, 147°, 146°, 145°, 144°, 143°, 142°, 141°, 140°, 139°, 138°, 137°, 136°, 135°, 134°, 133°, 132°, 131°, 130°, 129°, 128°, 127°, 126°, 125°, 124°, 123°, 122°, 121°, 120° 119°, 118°, 117°, 116°, 115°, 114°, 113°, 112°, 111°, 110°, 109°, 108° 107°, 106°, 105°, 104°, 103°, 102°, 101°, 100°, 99°, 98°, 97°, 96°, 95°, 94°, 93°, 92°, 91°, 90°, 89°, 88°, 87°, 86°, 85°, 84°, 83°, 82°, 81°, 80°, 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2°, 1° or 0°. A person skilled in the art understands that the angle β depends on the specific configuration and the stiffness of the materials used, i.e., the material of the supporting profile and the material of the protective cover element.

In another embodiment, it is conceivable that the supporting profile is a plate girder, in particular a sheet metal edge profile or a cast bar profile and/or an I-, P-, T-, H-, TH-, Z-, U- or a L profile, a hollow profile girder, in particular with a rectangular profile or a square profile, and/or a hollow box girder. The profile of the supporting profile is preferably a triangle, a rectangle, a hexagon, in particular a regular hexagon or a polygon. Plate girders, hollow profile girder and hollow box girders are characterized by their light weight and by the low material requirements for the production. The low weight in combination with consistent stability is particularly important with large protective covers, in particular in view of the sealing and the required preload force and/or support of the protective cover.

Furthermore, it is conceivable that the supporting profile is made of an inherently rigid plastic material, an inherently rigid plastic compound, a metal, a metal compound and/or a composite thereof. Suitable materials and their inherent properties are known to a person skilled in the art. Preferably, the supporting profile is made of aluminum. In connection with the disclosure, it has been discovered that in particular the combination of a physically rigid material with the specific configuration or shape of the supporting profile having the elongated cross section contributes to achieve the required preload force and/or support of the protective cover.

Furthermore, it is conceivable that the supporting profile has a second connecting means, the first connecting means being disposed on a first end the supporting profile and the second connecting means being disposed on a second end of the supporting profile opposite of the first end. Preferably, the second connecting means is designed to detachably connect, preferably also to detachably support, another protective cover element. According to the disclosure, it is also intended that the additional protective cover element is detachably supported at an angle ρ, which is formed between a plane, which is formed between the axis of the supporting profile and the second connecting means, and the direction of movement, the angle ρ being 0° to 180°. The definitions and conditions for angle β described in detail elsewhere apply to angle ρ.

In connection with the disclosure, it has been discovered that the protective cover element is detachably connected to the first and/or second connecting means of the supporting profile in a direct or indirect manner and by means of a suitable element, as has been described above. By means of this configuration, it is possible to increase the structure of the protective cover to any size in the direction of movement and to thus increase the maximum extension length. Furthermore, the structure of the protective cover is advantageous in that it can be stored in a space-saving manner because of repeat parts.

In another embodiment, it is conceivable that the first and/or second connecting means is a hinged, keder, clicking, clamping, locking, screwed, rivet and/or push-fit connection. Preferably, the first and/or second connecting means is a clamping profile made of aluminum. In this manner, it is possible to replace individual integrated protective cover elements for maintenance, servicing and/or repair purposes, since they can easily be assembled and disassembled on location. This allows a space-saving assembly without a lateral insertion because of the first and/or second connecting means according to the disclosure and the assembly can be carried out without tools by trained personnel. Since maintenance, servicing and/or repairs can take place on location by simply replacing the respective elements, maintenance-related costs can be reduced considerably and machine downtimes can be avoided altogether.

In yet another embodiment, the protective cover element is a folding element and/or a roller blind, the protective cover element being made of a plastic material, a plastic compound, a metal, in particular a thin sheet, a textile and/or a composite thereof. The term “folding element” is known to a person skilled in the art and relates to a band- or strip-shaped length-adjustable element. Preferably, the maximum length of the folding element corresponds to the predetermined range of movement of the protective cover. The term “roller blind” is known to a person skilled in the art and relates to an element that can be rolled up and/or wound on a shaft and is variable in length. Preferably, the maximum length of the roller blind corresponds to the predetermined range of movement of the protective cover. Suitable materials are known to a person skilled in the art.

Furthermore, it is conceivable that the protective cover element is foldable, rollable, inherently rigid, thermoplastic, transparent at least in sections and/or translucent at least in sections. It is known to a person skilled in the art that a thermoplastic material is a plastic material, which can be reversibly deformed within a certain temperature range. Additionally, a thermoplastic material can be welded. Furthermore, it is known to a person skilled in the art that a protective cover which is transparent and/or translucent at least in sections improves the lighting conditions in such a manner that incident light can at least partly get through the protective cover element, so that the lighting conditions on the respective other side of the protective cover can be improved significantly. This means that the protective cover according to the disclosure is also suitable as a roof cover in which the use of additional lighting inside the machine room is sometimes unnecessary, or the areas of application open up the possibility of using a protective cover in those cases in which this protection has not yet been provided. A person skilled in the art understands that the term “transparent at least in sections” and “translucent at least in sections” depends on the position of the protective cover in the predetermined range of movement.

In another embodiment, it is conceivable that the protective cover comprises at least one guide rail. It is conceivable that at least one guide element is comprised which is disposed in the area of the guide rail and which is connected to the guide rail in a form-fitting and/or force-fitting manner. Preferably, the guide element is detachably or inextricably connected and/or directly or indirectly connected to the axis. More preferably, the guide element can be disposed above the guide rail. In connection with the disclosure, it is conceivable that the guide rail is designed and/or aligned in a straight, curved, slanted and/or bent manner. Preferably, the protective cover has at least one, more preferably 2, 3, 4, 5, 6 or more, identical or different guide rails. Furthermore, it is conceivable that the at least two guide rails are synchronous to each other or differently designed and/or aligned and also extend parallel or in different directions. In this manner, it is possible to realize a defined and smooth guiding of the protective cover in order to prevent tilting and/or skipping. Furthermore, it is achieved that the supporting profile is supported in a defined and smooth manner. The cross section of the guide rail is of minor importance. It is conceivable that said cross section is circular, rectangular or polygon. The guide element can be a plain bearing or a slide to realize a sliding guidance on the guide rail. Furthermore, it is conceivable that the guide element is a roller or a sprocket which is rotatably mounted.

In another embodiment, it is conceivable that the guide rail is a circular guide and/or a gear rack guide. Preferably, the guide is a circular guide and a gear rack guide. As a circular guide, the embodiment is advantageous in that it has no edges, there is not as much chipping, it has less pollution and it allows a smooth, safe and resistance-free displaceability of a guide element. Apart from less components being required, the combination of a circular guide and a gear rack guide is also advantageous in that the height of the installation space can be decreased.

In yet another embodiment, it is conceivable that the protective cover has at least one drive unit. Preferably, the drive unit is detachably or inextricably and/or directly or indirectly connected to the guide rail by means of methods known to a person skilled in the art. The person skilled in the art is familiar with corresponding possibilities for connecting components. The term “drive unit” refers to a constructive unit which is suitable to introduce an energy, a force and/or a momentum into the guide rail and/or into an element, such as the guide element, directly or indirectly connected thereto, so that by means of the interaction a linear movement can be realized. Because of the linear movement, the supporting profile connected to the drive unit is moved within the predetermined range of movement. It is obvious to a person skilled in the art that the drive unit and the guide rail are in contact with each other by means of measures known to the person skilled in the art in order to ensure the displaceability of the protective cover. In connection with the disclosure, it is of minor importance how the drive unit is driven, positioned and/or designed. It is conceivable, for example, that the drive unit is driven by a combustion engine, electrically, hydraulically, pneumatically, manually and/or by a mixture thereof. Furthermore, it is conceivable that the drive unit has one or several transmission gearing(s). Preferably, it is conceivable that the protective cover has 1, 2, 3, 4, 5, 6 or more identical or differently designed drive unit(s).

The term “linear movement” relates to the defined movement of the protective cover within the range of movement predetermined by the first and second position of the protective cover, which is realized by the energy, force and/or the momentum introduced by the drive unit into the guide and/or into an element directly or indirectly connected thereto, such as the guide element, being converted into a linear movement. It is conceivable that the guide rail also comprises a guide element so that the conversion of the linear movement is effected on the basis of the interaction between the guide rail and the guide element. The term “linear” only describes a defined movement of the supporting profile, which is connected to the drive unit and/or the guide rail, along the guide rail in one, preferably two, direction(s) of movement, i.e., back and forth. A person skilled in the art understands that the linear movement is directly dependent on the design and/or the alignment of the guide. It is conceivable that the guide rail is straight, curved, slanted and/or bent, so that the linear movement resulting therefrom is in one, preferably two, defined direction(s) of movement, i.e., back and forth, is according to the design and/or alignment of the guide and is a straight, curved, slanted and/or bent movement.

Furthermore, it is conceivable that the protective cover comprises at least one fixed end frame and/or a shield. Suitable materials are known to a person skilled in the art.

Furthermore, it is conceivable that the supporting profile comprises at least one damper. The term “damper” is known to a person skilled in the art and relates to an element which is suitable for reducing unwanted vibrations, offsetting irregularities of, for example, the guide rail, realizing a stop function and/or a deceleration. According to the disclosure, it has been discovered that the damper is also suitable for separating the supporting profiles from each other and/or preventing a collision of the supporting profiles in the first position, i.e., in a state, when the protective cover is fully pushed together. Suitable dampers are known to a person skilled in the art. Preferably, it is conceivable that the supporting profile has at least 1, 2, 3, 4, 5, 6 or more identical or differently designed damper(s).

The definitions and/or the explanations of the terms mentioned above are assumed to apply to all aspects described in the following description, unless otherwise indicated.

Furthermore, the disclosure proposes a machine, in particular a machine tool, comprising at least one protective cover according to any one of the claims 1 to 15.

Other details, features and advantages of the disclosure are apparent from the following description of preferred embodiments in connection with the dependent claims. The respective features can be realized individually or in combination with each other. The disclosure is not limited to the embodiments. The embodiments are schematically illustrated in the figures. Identical reference signs in the individual figures designate similar elements, elements of similar functions or elements corresponding in terms of functionality.

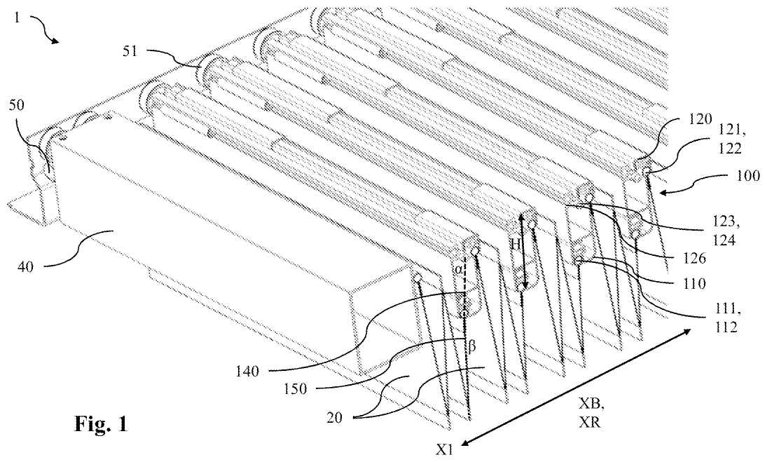

FIG. 1 is an isomeric illustration of a protective cover according to the disclosure in the first position;

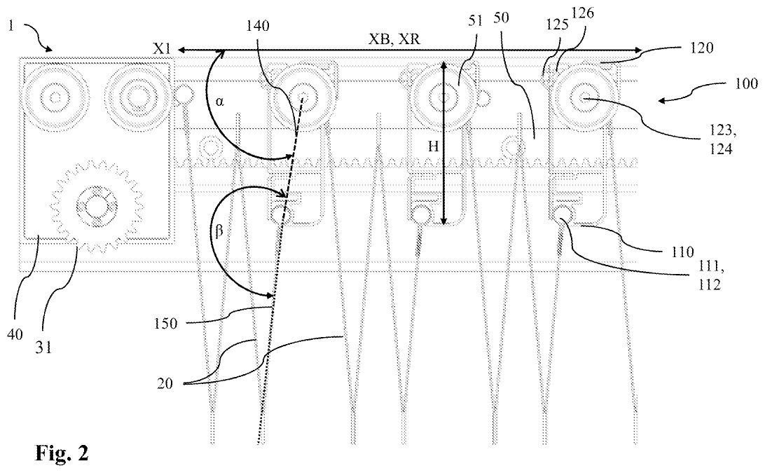

FIG. 2 is a side view of a protective cover according to the disclosure in the first position;

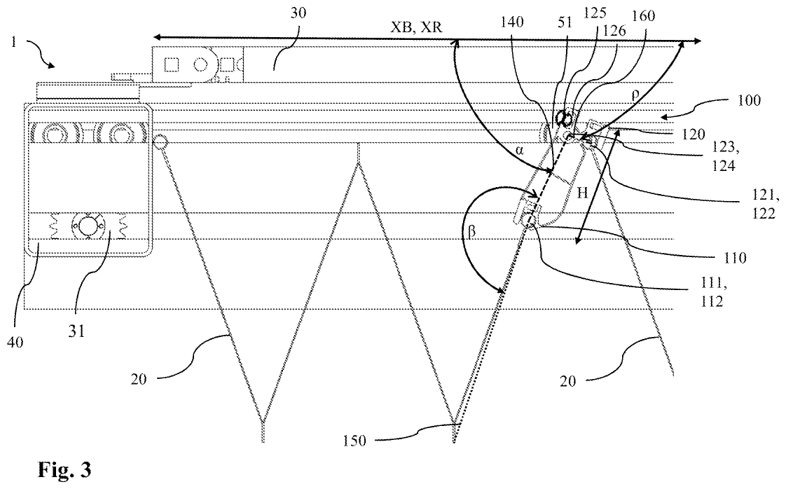

FIG. 3 is a sectional view of a protective cover according to the disclosure in a position which is between the first position and the second position;

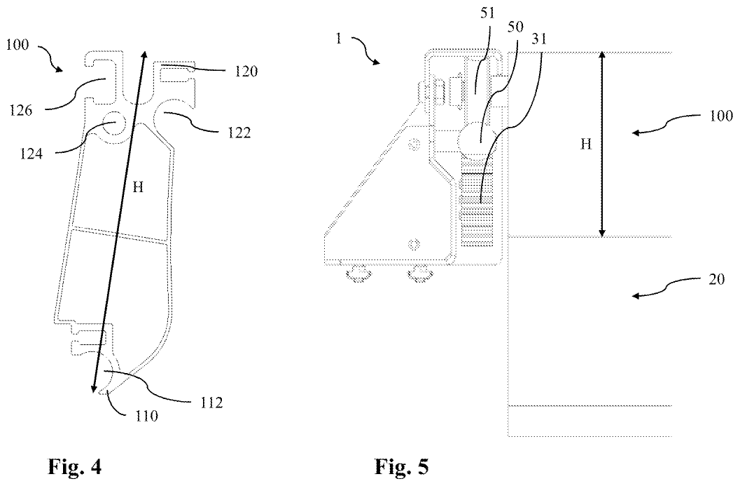

FIG. 4 is a sectional view of a supporting profile according to the disclosure; and

FIG. 5 is a front view of a protective cover according to the disclosure.

FIG. 1 shows an isometric illustration of a protective cover 1 according to the disclosure having a fixed end frame 40 when protective cover 1 is fully retracted, i.e., in a first position X1 of a predetermined range of movement XB of the direction of movement XR. It can be seen that protective cover 1 has several supporting profiles 100 which are evenly distributed in the direction of movement XR and which have a mount 112 for mounting a first connecting means 111 on a first end 110 and a mounting area 122 for a second connecting means 121 on an end 120 opposite first end 110. Furthermore, it can be seen that supporting profile 100 is connected to and forms a unit with a protective cover element 20, in this case, a folding element forming two folds, by means of first connecting means 111. Each unit is connected to protective cover element 20 of the adjacent unit via second connecting means 121. In this specific embodiment, first and second connecting means 111, 121, are a clamping profile made of aluminum, which allows to detachably connect protective cover element 20. In one embodiment, it is conceivable that protective cover element 20 can also be rotatably mounted at an angle (3, angle β being formable between a pivot plane 140 of supporting profile 100 and a center plane 150 of protective cover element 20. It can also be seen that supporting profile 100 has a mount 126 for a damper (not shown) and a mount 124 for an axis 123 on which supporting profile 100 is rotatably mounted.

Furthermore, it can be seen in FIG. 1 that supporting profile 100 is securely and movably guided on a circular guide 50 by means of a guide element in the manner of a roller 51 disposed on axis 123. It can be easily seen that the height of the elongated cross section H of supporting profile 100 is disposed essentially perpendicular to the direction of movement XR when protective cover 1 is fully retracted, i.e. in the first position X1. In this specific embodiment, angle α, which is formed between pivot plane 140 of supporting profile 100 and the direction of movement XR, amounts to approximately 90°.

FIG. 2 shows a side view of protective cover 1 from FIG. 1 according to the disclosure. It can be easily seen that supporting profile 100 has a guide element 51 in the form of a roller on either side of axis 123, on which said supporting profile 100 is rotatably mounted, supporting profile 100 being guided by means of said roller on guide rail 50 which is realized as a combined circular guide having a gear rack guide. Furthermore, FIG. 2 shows a drive wheel 31 in the form of a sprocket which is disposed in fixed end frame 40 and which is connected to a drive unit (now shown) and which engages in gear rack guide 50 and thus allows a smooth movement of protective cover 1 within the predetermined range of movement XB in the direction of movement XR. In FIG. 2, protective cover 1 is shown in the fully retracted state in the first position X1, in which the height of elongated cross section H of supporting profile 100 is disposed essentially perpendicular to the direction of movement XR. It can be easily seen in FIG. 2 that supporting profile 100 has a hollow-chamber profile having a rectangular cross section H, said supporting profile 100 also having a damper 125 which is disposed in mount 126, in addition to the elements described in FIG. 1.

FIG. 3 shows protective cover 1 according to the disclosure, which has been described in FIG. 1 and FIG. 2, when it is displaced in the direction of movement XR, said protective cover 1 being located between the fully retracted state in the first position and the fully extended state in the second position of the predetermined direction of movement XB. It can easily be seen that supporting profile 100 has a slightly modified elongated cross section H compared to the supporting profile of FIGS. 1 and 2, both having an elongated cross section H with a hollow-chamber profile.

Furthermore, it can be easily seen in FIG. 3 that angle α is formed between pivot plane 140 of supporting profile 100 and the direction of movement XR, whereas angle β can be formed between pivot plane 140 of supporting profile 100 and center plane 150 of protective cover element 20. Furthermore, it can be seen that an angle ρ can be formed between a plane 160 and the direction of movement XR, said plane 160 being formed between axis 123 of supporting profile 100 and second connecting means 121. First and second connecting means 111, 121, a clamping profile made of aluminum in this case, allow a detachable connection of protective cover element 20.

Just as the cross section of the supporting profile of FIGS. 1 and 2, the slightly modified elongated cross section H of the supporting profile in FIG. 3, shown in detail in FIG. 4, has a mount 112 disposed on a first end 110 for a first connecting means 111 for detachably connecting protective cover element 20, which is shown as a folding element forming two folds in this case. Furthermore, supporting profile 100 has a second end 120 opposite first end 110, on which a mount 122 for a second connecting means 121 is disposed for connecting an additional protective cover element 20. Furthermore, on its second end, supporting profile 100 has a mount 126 for a damper 125 and a mount 124 for axis 123 which rotatably mounts supporting profile 100. Furthermore, it can be easily seen that the energy, force and/or the momentum which can be introduced by means of drive unit 30 via drive wheel 31, shown as a sprocket in this case, can be introduced to guide rail 50 and roller 51 which is disposed above guide rail 50 and on axis 123.

FIG. 5 is a front view of protective cover 1 according to the disclosure, from which it can be seen that the installation height, i.e., the height of cross section H of supporting profile 100, essentially corresponds to the sum of the height of the drive unit, of guide rail 50 and of guide element 51 which is disposed on guide rail 50. Furthermore, protective cover element 20 connected to supporting profile 100 is shown

1. A protective cover having at least one supporting profile and having at least one length-adjustable protective cover element, the supporting profile having a first connecting means for detachably connecting the protective cover element, and the protective cover being movable in a direction of movement within a predetermined range of movement, which is defined between a first position of the protective cover and a second position of the protective cover,
wherein
the supporting profile is rotatably mounted around an axis in such a manner that the height of the cross section of the supporting profile is disposed essentially perpendicular to the direction of movement in the first position and parallel to the direction of movement in the second position.

2. The protective cover according to claim 1, wherein
the supporting profile has an elongated and/or high cross section.

3. The protective cover according to claim 1, wherein
the supporting profile is rotatably mounted at an angle (α), the angle (α) being 80° to 100° in the first position and/or 0° to 79° in the second position.

4. The protective cover according to claim 1,
wherein
the protective cover element is rotatably mounted, the protective cover element being rotatably mounted at an angle (β), the angle (β) being 0° to 180°.

5. The protective cover according to claim 1,
wherein
the supporting profile is a plate girder, a hollow profile girder and/or a hollow box girder.

6. The protective cover according to claim 1,
wherein
the supporting profile is made of an inherently rigid plastic material, an inherently rigid plastic compound, a metal, a metal compound and/or a composite thereof.

7. The protective cover according to claim 1,
wherein
the supporting profile has a second connecting means, the first connecting means being disposed on a first end of the supporting profile and the second connecting means being disposed on a second end of the supporting profile opposite of the first end.

8. The protective cover according to claim 1,
wherein
the first and/or second connecting means is a hinged, keder, clicking, clamping, locking, screwed, rivet and/or push-fit connection.

9. The protective cover according to claim 1,
wherein
the protective cover element is a folding element and/or a roller blind and is made of a plastic material, a plastic compound, a metal, a textile and/or a composite thereof.

10. The protective cover according to claim 8, wherein
the protective cover element is foldable, rollable, inherently rigid, thermoplastic, transparent at least in sections and/or translucent at least in sections.

11. The protective cover according to claim 1,
wherein
the protective cover has a guide rail.

12. The protective cover according to claim 11, wherein
the guide rail is a circular guide and/or a gear rack guide.

13. The protective cover according to claim 1,
wherein
the protective cover has at least one drive unit.

14. The protective cover according to claim 1,
wherein
the protective cover comprises an end frame and/or a shield.

15. The protective cover according to claim 1,
wherein
the supporting profile has at least one damper.

16. A machine comprising a protective cover according to claim 1.
